(19) United States
(12) Patent Application Publication
(10) Pub. No.: US 2008/0207073 A1
(43) Pub. Date: Aug. 28, 2008

(54) Coated multi-purpose fabric

(76) Inventor: David Michael Jones, Dacula, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/709,488

(22) Filed: Feb. 22, 2007

(51) Int. Cl. B32B 27/00

(52) U.S. Cl. 442/148

(57) ABSTRACT

A woven fabric coated in a single pass with a polymer blend to promote adhesion and impart abrasion resistance to the fabric simultaneously. An intimate blend of a binding thermoplastic and an abrasion resistant thermoplastic is extruded onto the woven fabric.

### FIELD OF THE INVENTION

This invention relates to a woven fabric that is coated with a polymer blend to promote adhesion and impart desired abrasion resistance.

### BACKGROUND OF THE INVENTION

Pool covers can be made from woven fabrics that are coated on at least one side to render the resulting coated fabric impermeable to fluid and moisture and thereby form a solid cover. Such solid covers are also resistant to ultraviolet light so that, when positioned over a pool, the fabric blocks sunlight from penetrating into the water and thereby prevents algae growth in the pool. The coating used on such woven fabrics typically includes an abrasion resistant polymer to enhance the integrity of the coating (prevent wearing away of the coating during use) and thus the solidity of the cover.

Woven polypropylene fabrics have been used to form solid pool covers. However, polypropylene used to make the woven fabric (and thus the resulting woven polypropylene fabric) has very poor adhesion characteristics and thus does not readily adhere to the coatings. Thus, woven polypropylene fabrics have been coated twice—first with a binding polymer and then with an abrasion resistant polymer. The binding polymer serves to enhance adhesion between the woven fabric and the abrasion resistant polymer.

However, this double coating process has proved problematic. Coating twice increases the manufacturing time and expense of the fabric. Moreover, delamination can occur between the two coatings, thereby jeopardizing the integrity and effectiveness of the resulting cover. Moreover, flaws (e.g., wrinkles) that occur during the first coating step are only more pronounced during the second coating step. Furthermore, it is desirable that the fabric be as light as possible. A fabric that is too heavy becomes stiff, rendering sewing and fabrication of the fabric into a pool cover difficult. Moreover, a fabric that is too heavy renders handling of the fabric during fabrication and handling of the resulting pool cover during installation difficult. Thus, there is a limit to the thickness that each of the coating layers may be. More specifically, in a two coating process only a limited amount of the binding polymer may be used and thus the resulting adhesion between the polypropylene fabric and the abrasion resistant coating (which is proportional to the amount of binding polymer used) is also limited. Furthermore, heating the fabric can make the fabric brittle or stiff. A double coating process requires that the fabric be heated twice—once before each coating step. This can detrimentally impact the integrity and tear resistance of the resulting fabric.

### SUMMARY OF THE INVENTION

This invention relates to a fabric for use in various applications, including recreational, agricultural, industrial, and horticultural applications. More specifically, the fabric can be a woven polypropylene fabric coated in a single pass with a polymer blend to promote adhesion and impart abrasion resistance to the fabric simultaneously. An intimate blend of a binding thermoplastic and an abrasion resistant thermoplastic is extruded onto the woven fabric. Prior to coating, the woven fabric is preferably treated (such as with Corona treatment and/or heat) to enhance the adhesion between the woven fabric and the polymer coating.

By blending the appropriate amount and type of binding and abrasion resistant thermoplastics, the fabric may be coated in a single pass. While coating in a single (versus double) pass obviously reduces manufacturing time and related expense, it also results in a better product. The risk of delamination between separate binding and abrasion resistant thermoplastic coating layers is avoided. Moreover, the risk of flaws from the first coating layer impacting the second layer is also obviated. Furthermore, the single coating may be thicker than each of the separate coatings in a double coating process, thereby enhancing adhesion between the woven fabric and the polymer coating. Finally, the present invention is an improvement over the double coating process of the past because the fabric need only be subjected to heat once, thereby limiting the fabric's exposure to heat and its consequent degradation from such exposure. Reducing heat exposure also enhances the tear resistance of the final coated fabric.

### DETAILED DESCRIPTION OF THE INVENTION

The present invention relates to a woven fabric that is coated on one side with a blend of a binding thermoplastic and an abrasion resistant thermoplastic. Coating a fabric can reduce its tear strength. The woven fabric may be made from polypropylene, polyethylene, or polyethylene terephthalate. In one embodiment, the woven fabric is a woven polypropylene fabric.

While any woven fabric may be used in accordance with this invention, it has been found that woven fabrics having certain features are particularly effective at increasing the tear strength of the final coated fabric. For example, oval-shaped warp yarns of between 500-1500 denier, inclusive, are particularly well-suited. Moreover, round fill yarns having a thickness between 10-20 mil or use of a tape in the weft direction are also effective. In one embodiment, the woven fabric is a plain weave fabric with 30 ends by 20 picks. The warp yarns are 930 denier oval yarns and the fill yarns are round 15 mil yarns or tape yarns. This fabric, when coated as disclosed below, had a tear strength of between 70-80 pounds (measured pursuant to ASTM D 4533). Again, however, the invention is certainly not limited to use of this particular woven fabric.

The binding thermoplastic may be any compound that preferably includes at least approximately 15-30% methyl acrylate and more preferably 20% methyl acrylate. The abrasion resistant thermoplastic can be a low density polyethylene (LDPE), a high density polyethylene (HDPE), or a linear low density polyethylene (LLDPE).

In one embodiment, the binding thermoplastic is ethyl methyl acrylate (EMA), and the abrasion resistant thermoplastic is LDPE. The polymer blend can include between approximately 50-90% EMA and approximately 10-50% LDPE. The blend preferably, but not necessarily, includes approximately 75% EMA and 25% LDPE or approximately 85% EMA and 15% LDPE.

The polymers are preferably melt blended and then extruded (such as through a slot die) in a single pass onto a side of the woven fabric to seal the openings in the woven fabric. It has been found that the polymers blend well and may be extruded at temperatures between 450°-600° Fahrenheit. The polymer blend may be extruded onto the woven fabric to have any thickness, but preferably has a thickness between 5.0 to 9.0 mils, inclusive.

Prior to coating, the surface of the woven fabric to be coated is preferably, but not necessarily, Corona treated. The Corona treatment alters the surface characteristics of the fabric to enhance its adhesion to the coating. Moreover, the fabric is preferably heated prior to coating. Such heating may be accomplished with, among other things, an infrared heater. For example, the fabric may be heated to between 200°-260° Fahrenheit inclusive, and preferably to between 235°-250° Fahrenheit inclusive. Such heating also improves the fabric's ability to adhere to the coating.

After optionally Corona treating and/or heating the fabric, the fabric may be passed under a slot die from which the polymer blend exits. In this way, a side of the fabric is coated with the polymer blend. After coating, the coated fabric can contact a chilled press roll to press the polymer blend into the openings in the woven fabric and cool the polymer blend on the fabric. The press roll should be of a material that the molten polymer will not adhere to, such as silicon or Teflon. The surface characteristics of the roll may be altered to impart a desired finish to the coating on the fabric (e.g., a mat finish).

While slot die coating is one way to coat the fabric, other means may be used to the fix the polymers to the woven fabric. For example, a film may be co-extruded to have one side of the binding thermoplastic and one side of the abrasion resistant thermoplastic. Alternatively, the polymers could first be blended and then extruded into a film. The film could then subsequently be married to the woven fabric, such as by, for example, heating the film and then laminating it to the woven fabric.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope.

We claim:

1. A solid fabric comprising a woven fabric coated with a polymer blend comprising a binding thermoplastic and an abrasion resistant thermoplastic.

2. The fabric of claim 1, wherein the woven fabric comprises at least one of polypropylene, polyethylene, or polyethylene terephthalate.

3. The fabric of claim 1, wherein the binding thermoplastic comprises approximately 15-30% methyl acrylate.

4. The fabric of claim 1, wherein the abrasion resistant thermoplastic comprises at least one of low density polyethylene, high density polyethylene, or linear low density polyethylene.

5. The fabric of claim 1, wherein the polymer blend comprises approximately 50-90% ethyl methyl acrylate.

6. The fabric of claim 1, wherein the polymer blend comprises approximately 10-50% low density polyethylene.

7. The fabric of claim 1, wherein the polymer blend comprises approximately 75% ethyl methyl acrylate and approximately 25% low density polyethylene.

8. The fabric of claim 1, wherein the polymer blend comprises approximately 85% ethyl methyl acrylate and approximately 15% low density polyethylene.

9. The fabric of claim 1, wherein the polymer blend is extruded on to the woven fabric.

10. The fabric of claim 9, wherein the woven fabric is Corona treated prior to extrusion.

11. The fabric of claim 9, wherein the woven fabric is heated prior to extrusion.

12. A method of forming a coated fabric comprising:
a. providing a woven fabric; and
b. extruding on a side of the woven fabric a polymer blend comprising a binding thermoplastic and an abrasion resistant thermoplastic.

13. The method of claim 12, wherein the woven fabric comprises at least one of polypropylene, polyethylene, or polyethylene terephthalate.

14. The method of claim 12, wherein the binding thermoplastic comprises approximately 15-30% methyl acrylate.

15. The method of claim 12, wherein the abrasion resistant thermoplastic comprises at least one of low density polyethylene, high density polyethylene, or linear low density polyethylene.

16. The method of claim 12, wherein the polymer blend comprises between approximately 50-90% ethyl methyl acrylate.

17. The method of claim 12, wherein the polymer blend comprises between approximately 10-50% low density polyethylene.

18. The method of claim 12, further comprising Corona treating the side of the woven polypropylene fabric prior to extrusion.

19. The method of claim 12, further comprising heating at least the side of the woven polypropylene fabric prior to extrusion.

20. A solid fabric comprising a woven polypropylene fabric coated with a polymer blend comprising a binding thermoplastic and an abrasion resistant thermoplastic, wherein the binding thermoplastic comprises ethyl methyl acrylate and the abrasion resistant thermoplastic comprises low density polyethylene.
